(19) United States
(12) Patent Application Publication
(10) Pub. No.: US 2018/0347919 A1
(43) Pub. Date: Dec. 6, 2018

(54) PRESSURE EQUALIZING ORIFICE FOR BAFFLES IN VANES

(71) Applicant: UNITED TECHNOLOGIES CORPORATION, Farmington, CT (US)

(72) Inventors: Brandon W. Spangler, Vernon, CT (US); Atul Kohli, Tolland, CT (US)

(21) Appl. No.: 15/608,795

(22) Filed: May 30, 2017

(51) Int. Cl. F28F 13/02; F01D 5/18; F01D 9/04; F01D 25/12

(52) U.S. Cl. CPC F28F 13/02; F01D 5/189; F01D 9/045; F05D 2240/126; F01D 25/12; F05D 2260/2214; F05D 2260/201; F01D 9/048

(57) ABSTRACT

Disclosed is a module for a gas turbine engine, the module including: a disk rotatable about an engine central axis and a vane fixedly disposed upstream of the disk, the vane being hollow and including a vane cavity, the vane cavity having a vane longitudinal span between a vane upstream opening and vane downstream opening, the vane including: a baffle fixedly supported within the vane cavity, the baffle having a hollow interior and having a baffle longitudinal span between a baffle upstream surface and a baffle downstream surface, the baffle longitudinal span being less than the vane longitudinal span to define a partial space eater baffle; wherein a baffle opening area fluidly connects the vane cavity to the baffle interior, and the baffle opening area is between 5.0×10̂−5 square inches and 1.5×10̂−3 square inches.

### STATEMENT OF FEDERAL SUPPORT

This invention was made with Government support under Contract Number FA8650-09-D-2923-0021 awarded by the United States Airforce. The Government has certain rights in the invention.

### BACKGROUND

Exemplary embodiments pertain to the art of baffle design and more specifically to baffles disposed in a vane cavity subject to a flow of cooling air.

With completely sealed baffles disposed in vane cavities in gas turbine engines under operating conditions, air inside the baffle may remain at atmospheric pressure while pressure in airflow outside of the baffle may be greater. Thick baffle walls or numerous ribs inside the baffle may be required to prevent the baffle from collapsing. The thick walls or extra ribs may result in extra weight and design complexity. Accordingly there is a need for a baffle design providing a lower pressure difference between the inside and outside of the baffle during operating conditions.

### BRIEF DESCRIPTION

Disclosed is a module for a gas turbine engine, the module comprising a disk rotatable about an engine central axis and a vane fixedly disposed upstream of the disk, the vane being hollow and including a vane cavity, the vane cavity having a vane longitudinal span between a vane upstream opening and vane downstream opening, the vane including: a baffle fixedly supported within the vane cavity, the baffle having a hollow interior and having a baffle longitudinal span between a baffle upstream surface and a baffle downstream surface, the baffle longitudinal span being less than the vane longitudinal span to define a partial space eater baffle; and wherein a baffle opening area fluidly connects the vane cavity to the baffle interior, and the baffle opening area is between 5.0×10̂−5 square inches to 1.5×10̂−3 square inches.

In addition to one or more of the features described above, or as an alternative, further embodiments may include a ratio of a baffle volume to a baffle opening area is between 10 inches and 500 inches.

In addition to one or more of the features described above, or as an alternative, further embodiments may include that a baffle volume is between 1.6×10̂−2 cubic inches and 0.4 cubic inches.

In addition to one or more of the features described above, or as an alternative, further embodiments may include that a baffle longitudinal span is between 0.3 inches and 2.0 inches.

In addition to one or more of the features described above, or as an alternative, further embodiments may include that the baffle upstream surface and baffle downstream surface each forms a wedge, and the baffle opening area is on a baffle upstream wedge vertex or a baffle downstream wedge vertex.

In addition to one or more of the features described above, or as an alternative, further embodiments may include that a baffle first side wall and a baffle second side wall, each baffle side wall extending between the baffle upstream surface and the baffle downstream surface, and the baffle opening area is on one or more of the baffle first side wall, the baffle second side wall, the baffle upstream surface and the baffle downstream surface.

In addition to one or more of the features described above, or as an alternative, further embodiments may include that the baffle opening area is distributed on each baffle side wall at a same longitudinal position.

In addition to one or more of the features described above, or as an alternative, further embodiments may include that the baffle downstream surface forms a wedge, and the baffle opening area is on a baffle side surface and on the baffle downstream vertex.

In addition to one or more of the features described above, or as an alternative, further embodiments may include that the baffle openings area is shaped as a circle, oval, racetrack or round-edge slot.

Further disclosed is a gas turbine engine comprising a module having one or more of the above features. Also disclosed is a method of equalizing pressure between a cavity of a vane and an interior of a baffle disposed within the vane, wherein the vane is in a module within a gas turbine engine, the module includes a rotating disk and the vane is upstream of the rotating disk, the vane cavity having a vane longitudinal span between a vane upstream opening and vane downstream opening, the baffle having a baffle longitudinal span between a baffle upstream surface and a baffle downstream surface, the baffle longitudinal span being less than the vane longitudinal span to define a partial space eater baffle; the method comprising: transferring a flow of cooling air through the vane cavity, from a radial outer end of the vane cavity to a radial inner end of the vane cavity; and diverting a portion of flow of cooling air into one or more baffle openings fluidly connecting the baffle cavity to the vane cavity; wherein a baffle opening area fluidly connects the vane cavity to the baffle interior, and the baffle opening area is between 5.0×10̂−5 square inches to 1.5×10̂−3 square inches. Moreover, the method may comprise one or more of the above disclosed features.

### BRIEF DESCRIPTION OF THE DRAWINGS

The following descriptions should not be considered limiting in any way. With reference to the accompanying drawings, like elements are numbered alike:

FIG. 1 is a partial cross section of a portion of a gas turbine engine according to an embodiment;

FIG. 2 illustrates baffles in a vane according to a disclosed embodiment;

FIGS. 3A-3D illustrate further details of baffles according to disclosed embodiments, where FIG. 3B illustrates the baffle of FIG. 3A cut along line B-B;

FIGS. 4A-4B illustrate further details of baffles according to disclosed embodiments;

FIGS. 5A-5D illustrate baffles according to disclosed embodiments;

FIGS. 6A-6D illustrate baffles according to disclosed embodiments; and

FIGS. 7A-7B illustrate baffles according to disclosed embodiments.

### DETAILED DESCRIPTION

A detailed description of one or more embodiments of the disclosed apparatus and method are presented herein by way of exemplification and not limitation with reference to the Figures.

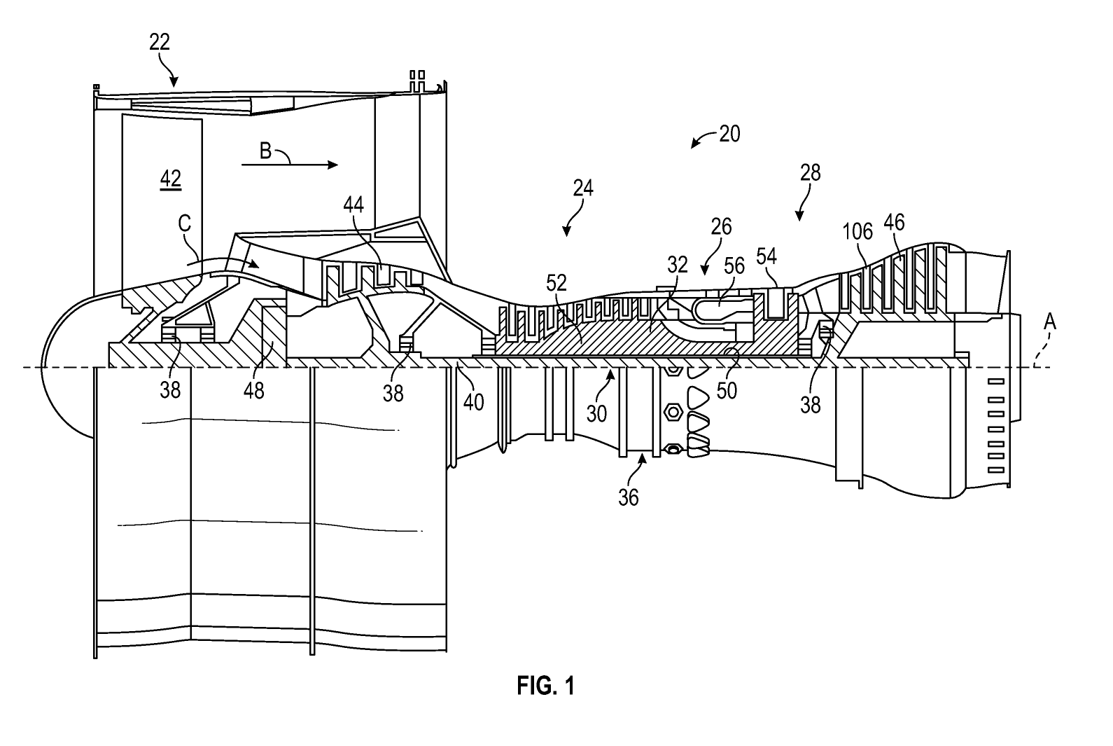

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7 °R)]^{0.5}. The “Low corrected fan tip speed” as disclosed herein according to one non-limiting embodiment is less than about 1150 ft/second (350.5 m/sec).

Further reference to features of the disclosed embodiments is made relative to a typical cylindrical coordinate system. The engine axis A illustrated in FIG. 1 is disposed along a longitudinal axis of the coordinate system and at a radial center or inner most portion of the coordinate system. The engine turbine section 28 is disposed downstream or aft of the compressor section 24.

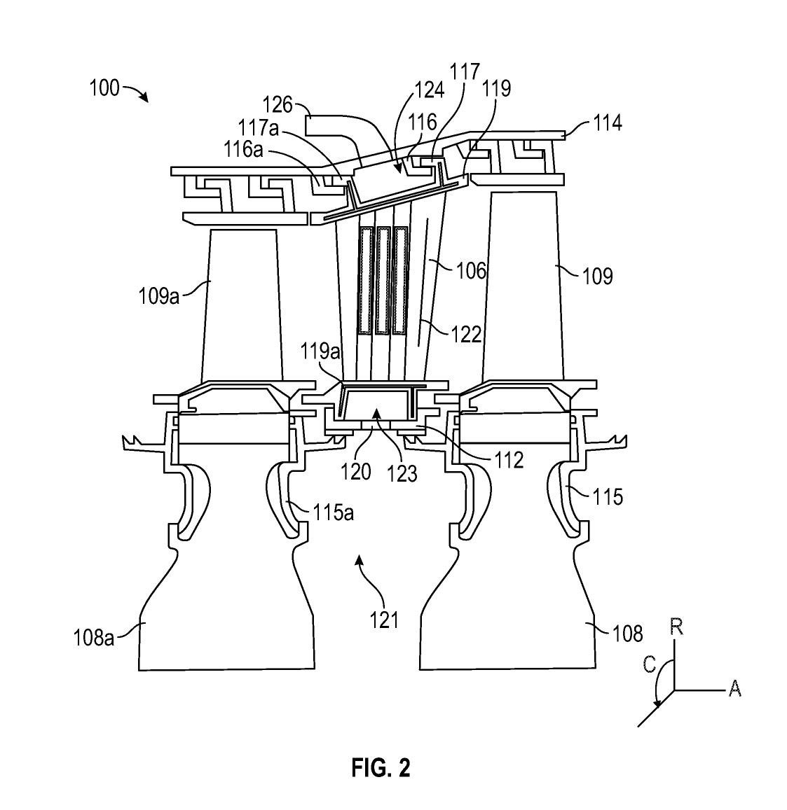

As illustrated in FIGS. 1 and 2, cooling designs in a turbine section 28 for a gas turbine engine 20 may utilize a vane 106 disposed between axially adjacent bladed full hoop disks 108, 108a having respective blades 109, 109a. Vane 106 may be disposed radially between an inner air seal 112 and a full hoop case 114 on an outer side. Inner air seal 112 may be a full hoop structure supported by opposing vanes, including vane 106, separated at one hundred and eighty (180) degrees in circumference. Vane 106 may be in turn supported by a full hoop case 114 through segmented vane hooks 117, 117a. Full hoop cover plates 115, 115a may minimize leakage between vane 106 and blades 109, 109a. Vane 106 may be radially supported by full hoop case 114 with segmented case hooks 116, 116a in mechanical connection with segmented vane hooks 117, 117a. Vane 106 may be circumferentially supported between circumferentially adjacent vanes by feather seals 119, 119a that may minimize leakage between the adjacent vanes into the gas path.

A turbine cooling air (TCA) conduit 126 may provide cooling air into an outer diameter vane cavity 124. Vane 106 may be hollow so that air may travel radially into and longitudinally downstream through vane 106 via a central vane cavity 122, and thereafter into a vane inner diameter cavity 123. Thereafter air may travel through an orifice 120 in inner air seal 112 and into a rotor cavity 121.

It is to be appreciated that the longitudinal orientation of vane 106 is illustrated in a radial direction, but other orientations for vane 106 are within the scope of the disclosure. In such alternate vane orientations, fluid such as cooling air flows into vane cavity 122 through an upstream opening illustrated herein as outer diameter cavity 124 and out through a downstream opening in vane cavity 122 illustrated herein as inner diameter cavity 123. A longitudinal span of vane cavity 122 being between such openings.

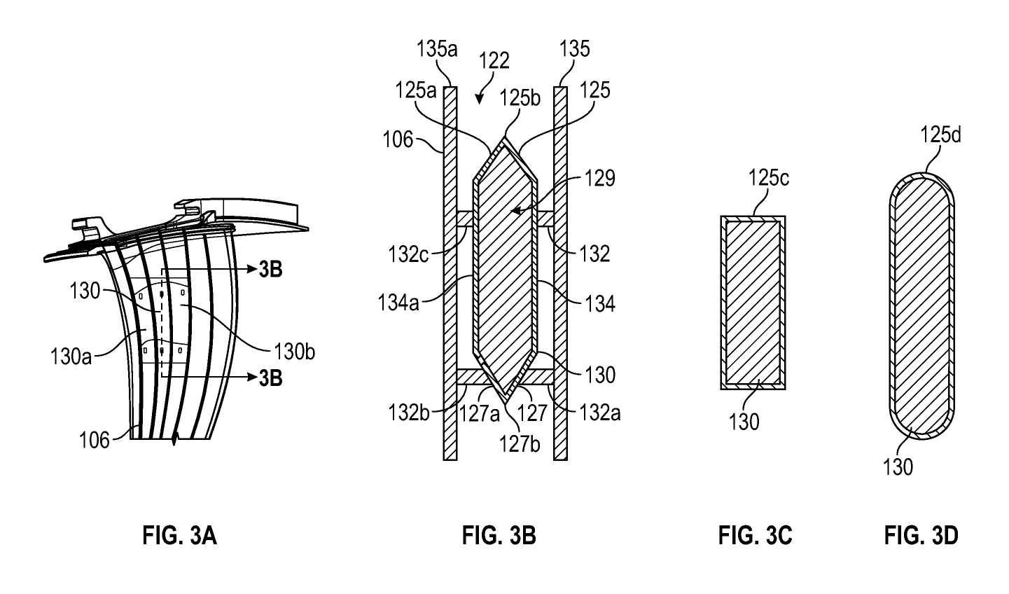

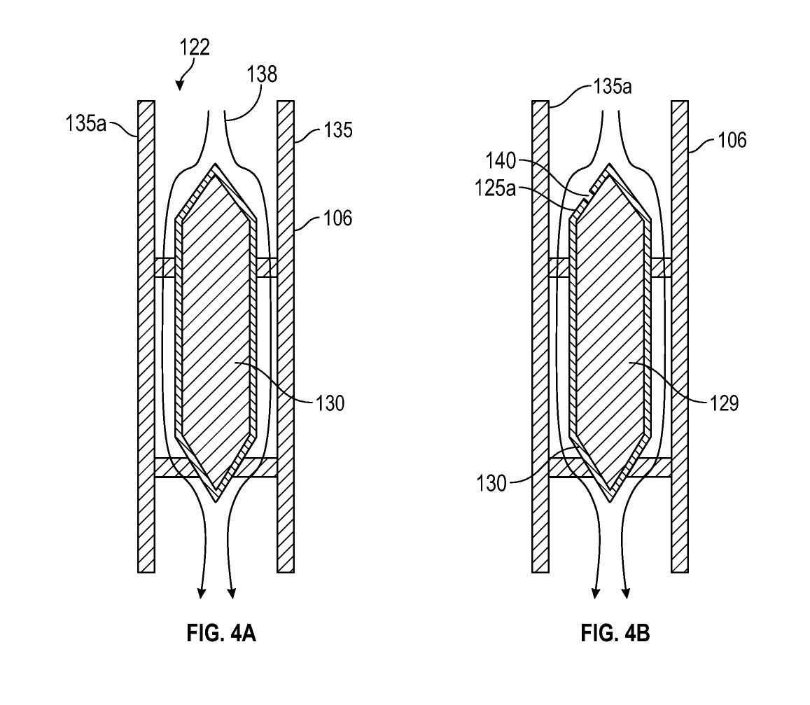

As illustrated in FIG. 3b, central vane cavity 122 may include longitudinally extending vane walls including suction-side vane wall 135 and pressure-side vane all 135a spaced therefrom. As illustrated in FIG. 4a, vane walls 135, 135a guide a flow 138 of turbine cooling air through vane 106.

As illustrated in FIG. 3a, within vane cavity 122 there may be one or more baffles 130, 130a, 130b, which may be partial space eater baffles which in the non-limiting illustration are axially adjacent and radially aligned with each other. The illustrated configuration is not intended to limit the number, shape or location of baffles within the guide vane 106. As illustrated in FIGS. 3a and 3b, partial space eater baffle 130 may have a smaller longitudinal span than the vane 106. Baffle 130 is illustrated as being centered within vane 106, but such position is not limiting.

Baffle 130 may be hollow and have an interior defining an internal baffle cavity 129. Baffle cavity 129 may have a plurality of baffle cavity walls, including longitudinal upstream walls 125, 125a, longitudinal downstream walls 127, 127a, a longitudinally extending suction-side wall 134 and a longitudinally extending pressure-side wall 134a. Though longitudinally extending side walls 134, 134a are illustrated herein as radially extending, it will be appreciated that the longitudinal orientation of the baffle 130 may be aligned with the longitudinal orientation of the vane 106.

Opposing end walls 125, 125a, 127, 127a meet at respective upstream apex 125b and downstream apex 127b to define respective profile shapes of an upstream and a downstream wedge. However, other shapes are known for the longitudinally outer walls of the partial space eater baffle 130, such as flat 125c in baffle 130 FIG. 3c and semi-circular 125d in baffle 130 in FIG. 3d. Baffle 130 may be positioned in vane 106 by baffle standoffs 132, 132a, 132b, 132c.

During engine operating conditions, with cooling air flowing upstream to downstream within the vane 106 pressure inside baffle cavity 129 may be atmospheric and substantially lower than pressure within vane cavity 122. This differential pressure may subject baffle 130 to a collapse.

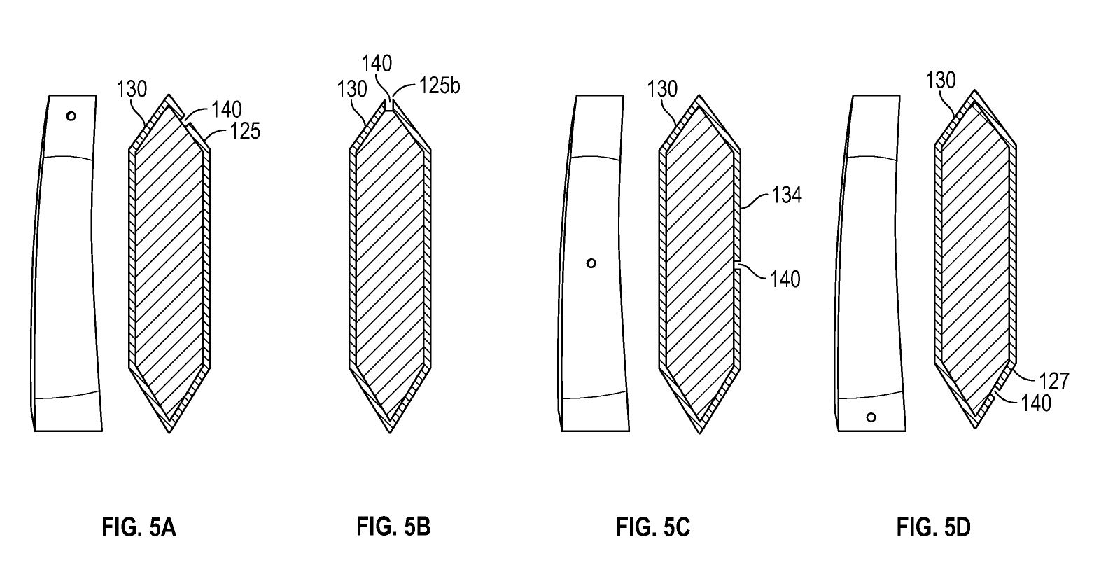

In FIG. 4b, baffle 130 may include an opening area defined by an opening 140 in upstream wall 125a of baffle 130, facing pressure-side wall 135a of vane 106. The opening 140 may pressurize the baffle cavity 129 at engine operating conditions. In FIG. 5a, opening 140 may be disposed on upstream wall 125 of baffle 130, facing suction-side wall 135 of vane 106. In FIG. 5b, opening 140 may be at upstream apex 125b of baffle 130. In FIG. 5c opening 140 may be on side wall 134 of baffle 130, facing suction-side wall 135 of vane 106. In FIG. 5d, opening 140 may be on downstream wall 127 of baffle 130, facing suction-side wall 135 of vane 106.

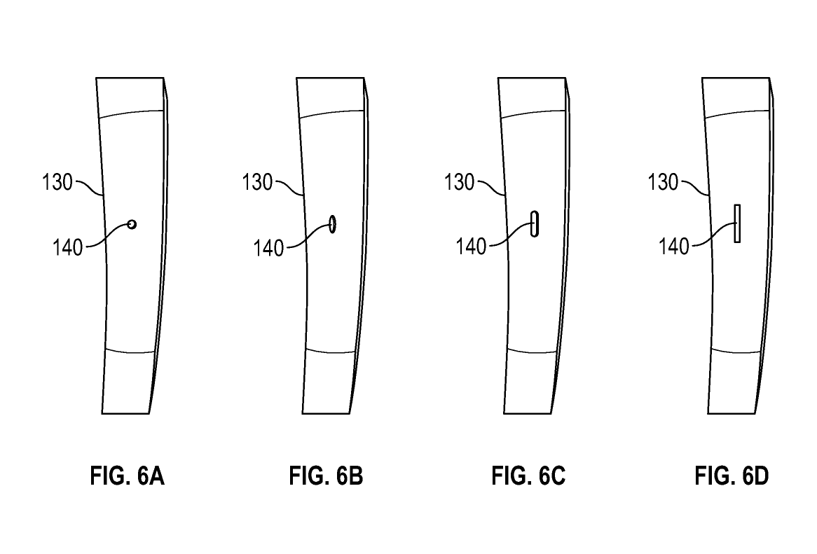

Turning to FIG. 6a, opening 140 in baffle 130 may be circular. In FIG. 6b, opening 140 may be oval. In FIG. 6c, opening 140 in baffle 130 may be in the shape of a racetrack or round-edged slot. In FIG. 6d, opening 140 in baffle 130 may be rectangular or in the shape of a square-edge slot. One of ordinary skill would recognize that the shapes illustrated herein are not limiting.

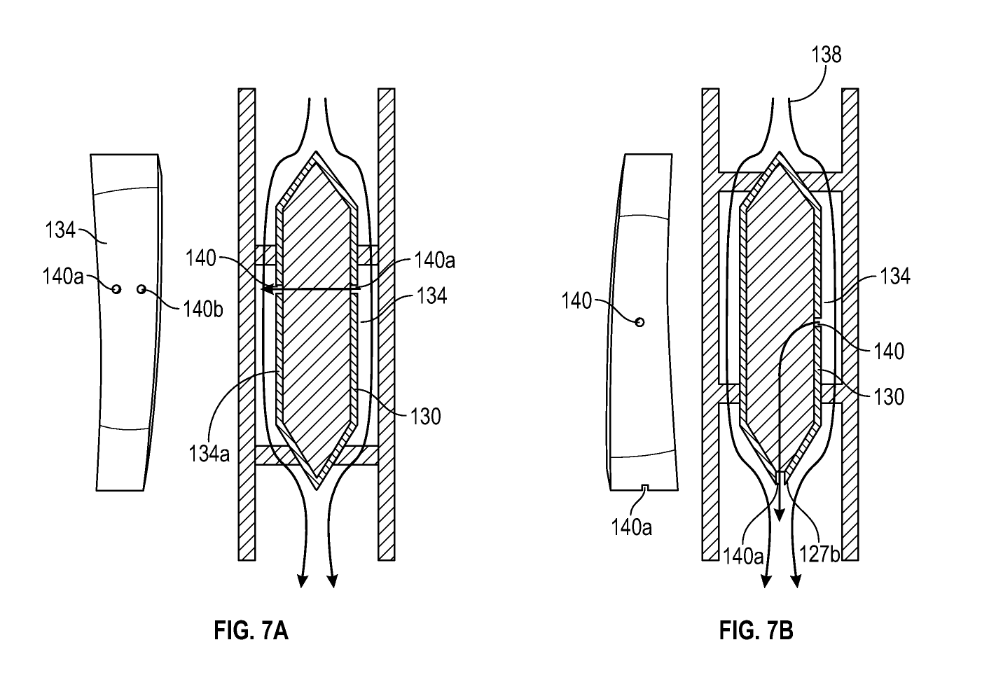

FIGS. 7a and 7b illustrate a plurality of openings in baffle 130. For example, in FIG. 7a, a plurality of openings 140, 140a, 140b may be distributed on both side walls 134, 134a of the baffle 130. In the illustration, there may be two openings, e.g., 140, 140b on each of the side walls 134, 134a, each being radially aligned. The plurality of openings may be used to ensure that pressures in and around the baffles 130 is equalized.

In FIG. 7b, plural openings 140, 140a are illustrated, one on side wall 134 of baffle 130 and one on downstream apex 127b of baffle 130. The combination of the two openings 140, 140a may allow some flow to travel through side wall 134a and exit apex 127b of baffle 130, filling in part of a wake generated by baffle 130, and merging in the same direction with cooling flow 138 outside baffle 130, which may minimizing pressure loss. Openings 140, 140a may be sized to tailor the flow in and around baffle 130. In addition, openings 140, 140a may be sized to keep a majority of the flow outside baffle 130.

To provide for pressure balancing, the baffle opening area may be between 5.0×10̂−5 square inches to 1.5×10̂−3 square inches. For example, a ratio of a baffle volume to a baffle opening area may be between 10 inches and 500 inches, the baffle volume may be between 1.6×10̂−2 cubic inches and 0.4 cubic inches, and in addition, baffle longitudinal span may be between 0.3 inches and 2.0 inches.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A module for a gas turbine engine, the module comprising:
a disk rotatable about an engine central axis and a vane fixedly disposed upstream of the disk, the vane being hollow and including a vane cavity, the vane cavity having a vane longitudinal span between a vane upstream opening and vane downstream opening, the vane including:
a baffle fixedly supported within the vane cavity, the baffle having a hollow interior and having a baffle longitudinal span between a baffle upstream surface and a baffle downstream surface, the baffle longitudinal span being less than the vane longitudinal span to define a partial space eater baffle; and
wherein a baffle opening area fluidly connects the vane cavity to the baffle interior, and the baffle opening area is between 5.0×10̂−5 square inches and 1.5×10̂−3 square inches.

2. The module of claim 1, wherein a ratio of a baffle volume to a baffle opening area is between 10 inches and 500 inches.

3. The module of claim 1, wherein a baffle volume is between 1.6×10̂−2 cubic inches and 0.4 cubic inches.

4. The module of claim 1, wherein a baffle longitudinal span is between 0.3 inches and 2.0 inches.

5. The module of claim 1, wherein the baffle upstream surface and baffle downstream surface each forms a wedge, and the baffle opening area is on a baffle upstream wedge vertex or a baffle downstream wedge vertex.

6. The module of claim 1, wherein the baffle includes a baffle first side wall and a baffle second side wall, each baffle side wall extending between the baffle upstream surface and the baffle downstream surface, and the baffle opening area is on one or more of the baffle first side wall, the baffle second side wall, the baffle upstream surface and the baffle downstream surface.

7. The module of claim 6, wherein the baffle opening area is distributed on each baffle side wall at a same longitudinal position.

8. The module of claim 6, wherein the baffle downstream surface forms a wedge, and the baffle opening area is on a baffle side surface and on the baffle downstream vertex.

9. The module of claim 1, wherein the baffle openings area is shaped as a circle, oval, racetrack or round-edge slot.

10. A gas turbine engine, comprising:
a module that includes a disk rotatable about an engine central axis and a vane fixedly disposed upstream of the disk, the vane being hollow and including a vane cavity, the vane cavity having a vane longitudinal span between a vane upstream opening and vane downstream opening, the vane including:
a baffle fixedly supported within the vane cavity, the baffle having a hollow interior and having a baffle longitudinal span between a baffle upstream surface and a baffle downstream surface, the baffle longitudinal span being less than the vane longitudinal span to define a partial space eater baffle; and
wherein a baffle opening area fluidly connects the vane cavity to the baffle interior, and the baffle opening area is between 5.0×10̂−5 square inches to 1.5×10̂−3 square inches.

11. The engine of claim 10, wherein a ratio of a baffle volume to a baffle opening area is between 10 inches and 500 inches

12. The engine of claim 10, wherein a baffle volume is between 1.6×10̂−2 cubic inches and 0.4 cubic inches.

13. The engine of claim 10, wherein a baffle longitudinal span is between 0.3 inches and 2.0 inches.

14. The engine of claim 10, wherein the baffle upstream surface and baffle downstream surface each forms a wedge, and the baffle opening area is on a baffle upstream wedge vertex or a baffle downstream wedge vertex.

15. The engine of claim 10, wherein the baffle includes a baffle first side wall and a baffle second side wall, each baffle side wall extending between the baffle upstream surface and the baffle downstream surface, and the baffle opening area is on one or more of the baffle first side wall, the baffle second side wall, the baffle upstream surface and the baffle downstream surface.

16. The engine of claim 15, wherein the baffle opening area is distributed on each baffle side wall at a same longitudinal position.

17. The engine of claim 15, wherein the baffle downstream surface forms a wedge, and the baffle opening area is on a baffle side surface and on the baffle downstream vertex.

18. The engine of claim 10, wherein the baffle openings area is shaped as a circle, oval, racetrack or round-edge slot.

19. The engine of claim 18, wherein the one or more baffle openings is shaped as a circle, oval, racetrack or round-edge slot.

20. A method of equalizing pressure between a cavity of a vane and an interior of a baffle disposed within the vane, wherein the vane is in a module within a gas turbine engine, the module includes a rotating disk and the vane is upstream of the rotating disk,
the vane cavity having a vane longitudinal span between a vane upstream opening and vane downstream opening, the baffle having a baffle longitudinal span between a baffle upstream surface and a baffle downstream surface, the baffle longitudinal span being less than the vane longitudinal span to define a partial space eater baffle;
the method comprising:
transferring a flow of cooling air through the vane cavity, from an upstream opening of the vane cavity to a downstream opening of the vane cavity; and
diverting a portion of flow of cooling air into one or more baffle openings fluidly connecting the baffle cavity to the vane cavity;
wherein a baffle opening area fluidly connects the vane cavity to the baffle interior, and the baffle opening area is between 5.0×10̂−5 square inches to 1.5×10̂−3 square inches.
